(19) United States
(12) Patent Application Publication
(10) Pub. No.: US 2010/0019064 A1
(43) Pub. Date: Jan. 28, 2010

(54) NOZZLE FOR FORMING HOLES ON INSULATORS

(75) Inventor: Shintaro Yanagisawa, Toda-shi (JP)

Correspondence Address: APEX JURIS, PLLC, 12733 LAKE CITY WAY NORTHEAST, SEATTLE, WA, 98125, US

(73) Assignees: Yi-Lu He, Zhubei City (TW); Shintaro Yanagisawa, Toda-shi (JP)

(21) Appl. No.: 12/180,420

(22) Filed: Jul. 25, 2008

(51) Int. Cl. B05B 7/04

(52) U.S. Cl. 239/418; 239/432

(57) ABSTRACT

A nozzle for forming holes on insulators aims to form a micro-hole on a targeted object without producing coarse circumferential surface. It includes a nozzle body, a connection duct and a fastening ring to fasten the nozzle body to the connection duct. The connection duct has an air connector coupling with a compressed air supply tube and a liquid connector coupling with a solvent supply tube. The solvent supplied by the solvent supply tube is atomized by the compressed air delivered by the compressed air supply tube and ejected through the nozzle body. Thus the micro-hole can be formed on the targeted object without producing uneven circumferential surface.

### FIELD OF THE INVENTION

The present invention relates to a drilling apparatus to form micro-holes on insulators and particularly to a nozzle for drilling holes on insulators to fabricate optical windows used on image detection device modules.

### BACKGROUND OF THE INVENTION

Conventional fabrication processes for insulators include shaping, cutting and etching and the like. To fabricate optical windows of precision optical equipments and the like micro-holes have to be formed by drilling on the insulators. For instance, image detection device modules used on mobile phones or digital cameras have an optical window on the incident side of a detection element. Light passes through a window opening of the optical window to form a photo image. The optical window is made from an insulator.

The window opening is formed at a size slightly larger than the incident surface of the detection element. The detection element generally includes CCDs. Advance of micro-fabrication techniques allows elements to be made more integrated, such as high resolution (or high pixel) articles. The detection element becomes smaller, so does the window opening. This is to meet miniaturizing requirement of mobile phones and the like.

To fabricate the optical window with a miniaturized window opening, a micro-hole has to be formed on an insulator through a hole drilling process. To do such a process in practice, such as one used in fabricating LCD elements, some adopt a sand blasting method. Although the sand blasting method can be used to fabricate the optical window, the circumferential surface of the hole being formed is coarse and uneven. As a result, the aesthetic appeal of the product such as the mobile phone suffers. Moreover, the uneven surface causes light scattering and could affect optical characteristics. Thus it cannot fully meet requirements.

### SUMMARY OF THE INVENTION

The primary object of the present invention is to provide a nozzle to fabricate optical windows of image detection device modules by drilling a micro-hole on a targeted object without forming uneven circumference of the hole.

To achieve the foregoing object, the drilling nozzle of the invention includes a nozzle body and a connection duct. The connection duct has an air connector on a right side to couple with a compressed air supply tube and a liquid connector on a left side to couple with a solvent supply tube. The connection duct also has a transverse air intake tube in the center communicating with the air connector. The air intake tube has a pointed end forming an air ejection duct at a lower side thereof protrusive downwards. The connection duct further has a main recess formed in the center of a lower surface thereof. The air ejection duct is extended downwards in the main recess and communicates with the air intake tube and the main recess.

The connection duct further has a transverse liquid intake port in the center communicating with the liquid connector. The liquid intake port is located slightly below the air intake tube and leads to a side wall of the main recess to communicate therewith.

The nozzle body is a barrel with a passage running through up and down. It has one end wedged in the main recess. The passage is enlarged slightly at one end and forms an ejection vent at the other end. The air ejection duct has a lower end located where the passage is enlarged and forms a gap with the nozzle body without in contact therewith.

By means of the construction set forth above, the nozzle of the invention can form a micro-hole on a targeted object. Through the liquid connector, a solvent which can etch the targeted object can be supplied. The air connector allows the solvent to be atomized and ejected at a selected pressure so that the micro-hole is formed without producing uneven on the circumferential surface. The micro-hole thus formed a smooth circumference and is aesthetic appealing.

The foregoing, as well as additional objects, features and advantages of the invention will be more readily apparent from the following embodiment and detailed description which proceeds with reference to the accompanying drawings. It is to be noted that the embodiment serves only for illustrative purpose and is not the limitation of the invention.

### BRIEF DESCRIPTION OF THE DRAWINGS

FIG. 1 is an exploded view of the invention.

FIG. 2 is a sectional view of the invention

FIG. 3 is a sectional view of the invention in a use condition.

### DETAILED DESCRIPTION OF THE PREFERRED EMBODIMENT

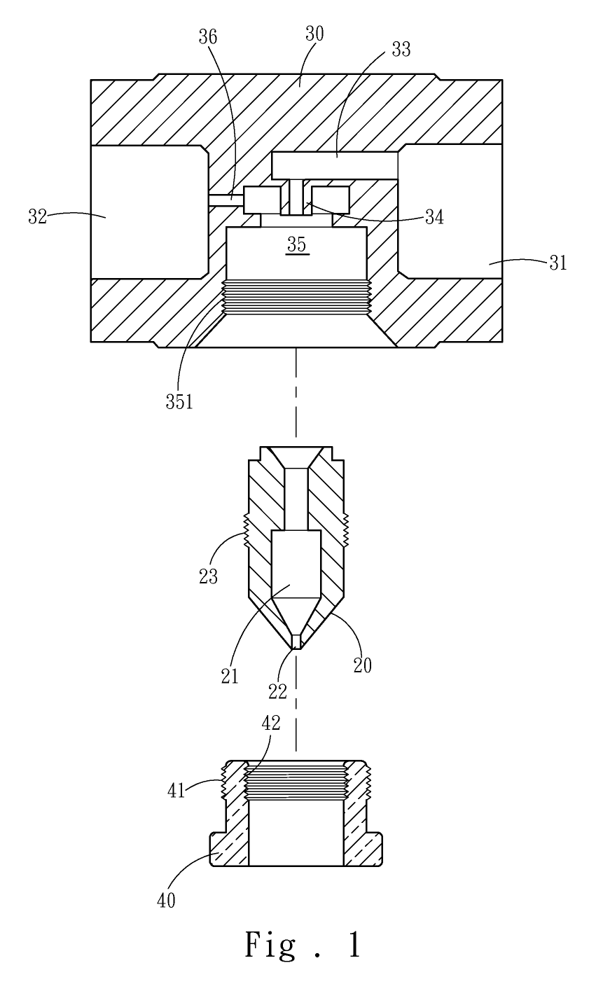

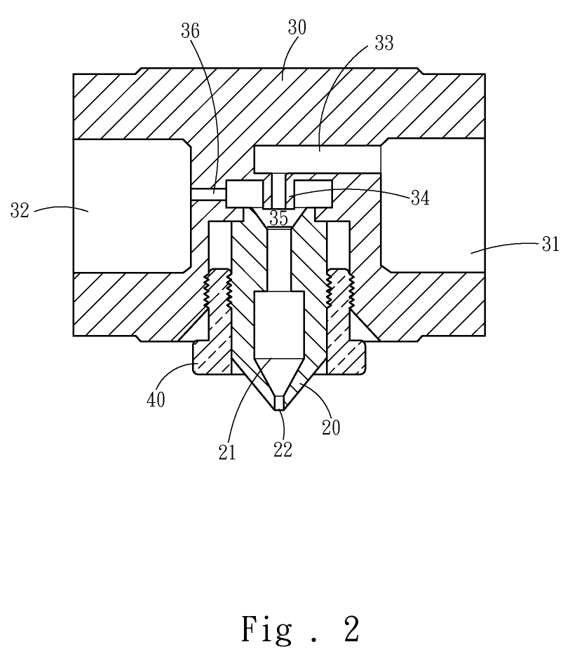

Please refer to FIGS. 1 and 2, the nozzle for forming holes on insulators according to the invention includes a nozzle body 20, a connection duct 30 and a fastening ring 40. The connection duct 30 has an air connector 31 on the right side to couple with a compressed air supply tube and a liquid connector 32 on the left side to couple with a solvent supply tube. The air connector 31 is a recess wedged in the compressed air supply tube. The liquid connector 32 is another recess wedged in the solvent supply tube.

The connection duct 30 also has a transverse air intake tube 33 formed in the center communicating with the air connector 31. The air intake tube 33 has a pointed end forming an air ejection duct 34 at a lower side thereof protrusive downwards. The connection duct 30 further has a main recess 35 in the center of a lower surface thereof. The air ejection duct 34 is extended downwards in the main recess 35 to communicate with the air intake tube 33 and the main recess 35.

The connection duct 30 further has a transverse liquid intake port 36 in the center communicating with the liquid connector 32 and leading to a side wall of the main recess 35 to form communication therewith.

The nozzle body 20 is a barrel with a passage 21 running through up and down. It has one end wedged in the main recess 35. The passage 21 has one end enlarged slightly and the other end forming an ejection vent 22. The air ejection duct 34 has a lower end located in the enlarged portion of the passage 21 without in contact with the nozzle body 20 but forming a gap therewith.

The fastening ring 40 is interposed between the main recess 35 and the nozzle body 20 to anchor the nozzle body 20 on the connection duct 30. The main recess 35 has a lateral side forming a thread portion 351. The nozzle body 20 has another thread portion 23 formed on the periphery thereof. The fastening ring 40 also has an external thread portion 41 and an internal thread portion 42 engageable respectively with the thread portions 351 and 23.

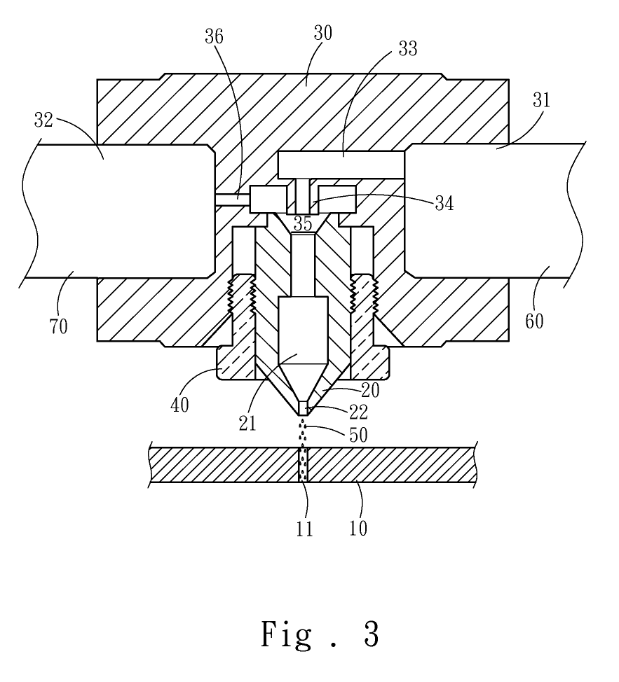

Referring to FIG. 3, the nozzle of the invention aims to drill a micro-hole 11 on a targeted object 10. It is connected to the compressed air supply tube 60 and the solvent supply tube 70 to receive compressed air and the solvent 50. The supplied compressed air is channeled through the air intake tube 33 to the air ejection duct 34 to be ejected into the main recess 35. The solvent 50 is channeled through the liquid intake port 36 into the main recess 35. After the solvent 50 has filled up the main recess 35, it flows downwards through the passage 21 of the nozzle body 20 to be ejected through the ejection vent 22 at one end of the passage 21. The compressed air ejected from the air ejection duct 34 blends forcefully with the solvent 50 such that the solvent 50 is dispersed while flowing downwards. As a result, the solvent 50 is ejected through the ejection vent 22 in the form of fine particles (in an atomized or water mist fashion). By selecting suitable parameters such as the pressure of the compressed air, delivery pressure of the solvent 50, opening size of the lower end of the air ejection duct 34, cross section area of the main recess 35, cross section area of the passage 21, and the size and shape of the ejection vent 22, the particles of the solvent 50 can be formed at a desired size and ejected at an intended pressure.

As a conclusion, the nozzle of the invention, by adjusting the parameters such as the pressure of the compressed air, delivery pressure of the solvent 50, opening size at the lower end of the air ejection duct 34, cross section area of the main recess 35, cross section area of the passage 21 and the size and shape of the ejection vent 22, allows the solvent 50 to form particles at a size larger than 20 μm and smaller than 400 μm to be ejected to form the micro-hole 11 on the targeted object 10 without producing uneven circumferential surface to meet use requirements.

What is claimed is:

1. A nozzle for forming holes on insulators, comprising:
a connection duct which has an air connector on a right side, a liquid connector on a left side and a transverse air intake tube in the center communicating with the air connector; the air intake tube having a pointed end to form an air ejection duct at a lower side thereof that is protrusive downwards; the connection duct also having a main recess in the center of a lower surface thereof, the air ejection duct being extended downwards in the main recess and communicating with the air intake tube and the main recess; the connection duct further having a transverse liquid intake port in the center lower than the air intake tube to communicate with the liquid connector and lead to a side wall of the main recess to form communication therewith; and
a nozzle body which has a passage running through up and down thereof and one end wedged in the main recess; the passage having one end enlarged slightly and the other end forming an ejection vent; the air ejection duct having a lower end located in the enlarged portion of the passage without in contact with the nozzle body but forming a gap therewith.

2. The nozzle for forming holes on insulators of claim 1 further having a fastening ring interposed between the main recess and the nozzle body to anchor the nozzle body on the connection duct.

3. The nozzle for forming holes on insulators of claim 2, wherein the main recess has a lateral side forming a thread portion and the nozzle body has another thread portion formed on the periphery thereof, the fastening ring having corresponding thread portions engageable with the thread portions of the main recess and the nozzle body.
